(19) United States
(12) Patent Application Publication
(10) Pub. No.: US 2005/0280521 A1
(43) Pub. Date: Dec. 22, 2005

(54) Display device, instrument panel, automotive vehicle and game system

(75) Inventor: Hidetaka Mizumaki, Nara-shi (JP)

Correspondence Address: KEATING & BENNETT, LLP, 8180 GREENSBORO DRIVE, SUITE 850, MCLEAN, VA, 22102, US

(73) Assignee: Sharp Kabushiki Kaisha

(21) Appl. No.: 11/153,748

(22) Filed: Jun. 15, 2005

(30) Foreign Application Priority Data
Jun. 22, 2004 (JP) 2004-183479

(51) Int. Cl. B60Q 1/00; G09G 3/36

(52) U.S. Cl. 340/438; 345/87

(57) ABSTRACT

The display device according to the present invention includes a display panel for displaying objects based on externally-input information. The display device is capable of displaying a first object representing the magnitude of a predetermined parameter on the display panel, and displaying a second object in association with the first object, the second object representing an amount of change, per predetermined period, in the magnitude of the parameter represented by the first object.

### BACKGROUND OF THE INVENTION

1. Field of the Invention

The present invention relates to a display device. The present invention also relates to: an instrument panel having a display device; an automotive vehicle such as an automobile (car); and a game system. Furthermore, the present invention also relates to a display device driving method and a computer program.

2. Description of the Related Art

A car instrument panel has conventionally been equipped with instruments such as a speedometer and/or a tachometer. In recent years, instead of such instruments, it has been proposed to provide a display device on the instrument panel, the display device displaying parameters concerning the vehicle status, e.g., engine revolution and vehicle speed (see, for example, Japanese Laid-Open Patent Publication No. 9-123848).

FIG. 13 schematically shows a display device 600 for use on an instrument panel. Although FIG. 13 illustrates one example where vehicle speed and engine revolution are displayed, arbitrary choices can be made as to which parameters are to be displayed, in which position on the display screen, and in what manner. Therefore, by providing the display device 600 on the instrument panel, it becomes possible to arbitrarily change the displaying layout of various parameters. It also becomes possible to optionally display additional information, such as car navigation information for allowing the driver of a current position and/or a route to a destination while the driver is operating the vehicle.

Although FIG. 13 illustrates displayed images resembling needle-and-dial type meters, the displayed images may alternatively be in the form of digital meters on which changing numerical figures are shown with time. However, in terms of visual reality, a large number of users prefer needle-and-dial type displays resembling a conventional speedometer and tachometer, as far as vehicle speed and engine revolution are concerned.

However, parameters concerning the vehicle status must be displayed in real time. Therefore, if a display device with a slow response speed is employed, the displayed parameter images may appear awkward.

For example, if a liquid crystal display device is employed as a display device, afterimages of the needles may occur as shown in FIG. 14. Such afterimages, which would not be observed on conventional meters, would present substantial awkwardness to the driver.

### SUMMARY OF THE INVENTION

In order to overcome the problem described above, the present invention has a main objective of displaying predetermined parameters which are in accordance with externally-input information on a display device without presenting awkwardness, regardless of whether the response speed of the display device is relatively fast or slow.

A display device according to the present invention comprises a display panel for displaying objects based on externally-input information, wherein the display device is capable of displaying a first object representing a magnitude of a predetermined parameter on the display panel, and the display device is capable of displaying a second object in association with the first object, the second object representing an amount of change, per predetermined period, in the magnitude of the parameter represented by the first object. Thus, the aforementioned objective is met.

In a preferred embodiment, the first object represents the magnitude of the parameter through a displayed position of the first object.

In a preferred embodiment, the second object represents the amount of change through a displayed area of the second object, the second object being displayed so as to follow the first object with changes in the displayed position of the first object.

In a preferred embodiment, the first object has a bar-like shape.

In a preferred embodiment, the first object having the bar-like shape is displayed so as to rotate around a first end of the first object in accordance with changes in the magnitude of the parameter, while a position of a second end of the first object indicates the magnitude of the parameter.

In a preferred embodiment, the second object has a shape forming a sector of a circle whose center is at the first end of the first object.

In a preferred embodiment, the displayed area of the second object becomes larger as the amount of change is larger.

In a preferred embodiment, the second object selectively represents only a positive or negative amount of change in the magnitude of the parameter per predetermined period.

In a preferred embodiment, the display device further comprises a control circuit for controlling the display panel to display the first and second objects.

In a preferred embodiment, the control circuit includes: a first circuit for periodically generating coordinate data defining a position at which to display the first object based on externally-input information; and a second circuit for determining a position at which to display the second object and a displayed area of the second object, through calculation of the coordinate data periodically generated by the first circuit and stored over a plurality of periods.

In a preferred embodiment, the display panel is a liquid crystal display panel including a pair of opposing substrates and a liquid crystal layer disposed between the pair of substrates.

In a preferred embodiment, the display device is a display device for an instrument panel to be mounted in an automotive vehicle, wherein the first object represents a magnitude of speed of the automotive vehicle, and the second object represents a magnitude of acceleration of the automotive vehicle.

In a preferred embodiment, the display device is a display device for an instrument panel to be mounted in an automotive vehicle, wherein the first object represents a number of revolutions of an engine or motor of the automotive vehicle.

An instrument panel according to the present invention comprises a display device having the above structure. Thus, the aforementioned objective is met.

An automotive vehicle according to the present invention comprises an instrument panel having the above structure. Thus, the aforementioned objective is met.

A game system according to the present invention comprises: a display device having the aforementioned structure; and an input device for inputting, to the display device, information which is in accordance with an operation by a user. Thus, the aforementioned objective is met.

In a preferred embodiment, the game system is to be used by the user for simulated driving of an automotive vehicle.

In a preferred embodiment, the first object represents the magnitude of speed of the automotive vehicle as determined through an operation by the user, and the second object represents the magnitude of acceleration of the automotive vehicle as determined through an operation by the user.

In a preferred embodiment, the first object represents a number of revolutions of an engine or motor of the automotive vehicle as determined through an operation by the user.

A display device driving method according to the present invention for driving a display device including a display panel for displaying objects based on externally-input information comprises the steps of: displaying a first object representing a magnitude of a predetermined parameter; and displaying a second object in association with the first object, the second object representing an amount of change, per predetermined period, in the magnitude of the parameter represented by the first object. Thus, the aforementioned objective is met.

In a preferred embodiment, the step of displaying the first object is performed so as to display the first object at a position which is in accordance with the magnitude of the parameter.

In a preferred embodiment, the step of displaying the second object is performed so as to display the second object with an area which is in accordance with the amount of change, the second object being displayed so as to follow the first object with changes in the displayed position of the first object.

In a preferred embodiment, the display device driving method further comprises the steps of: periodically generating coordinate data defining a position at which to display the first object based on externally-input information; and determining a position at which to display the second object and a displayed area of the second object, through calculation of the periodically-generated coordinate data as stored over a plurality of periods.

A computer program according to the present invention, which is executable by a display device including a display panel for displaying objects based on externally-input information on the display panel, causes the display device to perform the steps of: displaying a first object representing a magnitude of a predetermined parameter; and displaying a second object in association with the first object, the second object representing an amount of change, per predetermined period, in the magnitude of the parameter represented by the first object. Thus, the aforementioned objective is met.

In a preferred embodiment, the step of displaying the first object is performed so as to display the first object at a position which is in accordance with the magnitude of the parameter.

In a preferred embodiment, the step of displaying the second object is performed so as to display the second object with an area which is in accordance with the amount of change, the second object being displayed so as to follow the first object with changes in the displayed position of the first object.

In a preferred embodiment, the computer program further causes the display device to perform the steps of: periodically generating coordinate data defining a position at which to display the first object based on externally-input information; and determining a position at which to display the second object and a displayed area of the second object, through calculation of the periodically-generated coordinate data as stored over a plurality of periods.

A display device according to the present invention is capable of displaying a first object representing the magnitude of a predetermined parameter on the display panel, and displaying a second object in association with the first object, the second object representing an amount of change, per predetermined period, in the magnitude of the parameter represented by the first object. Thus, without presenting awkwardness, it is possible to display predetermined parameters which are in accordance with externally-input information, regardless of whether the response speed is relatively fast or slow.

A display device driving method according to the present invention comprising the steps of: displaying a first object representing a magnitude of a predetermined parameter; and displaying a second object in association with the first object, the second object representing an amount of change, per predetermined period, in the magnitude of the parameter represented by the first object. Thus, without presenting awkwardness, it is possible to display predetermined parameters which are in accordance with externally-input information, regardless of whether the response speed is relatively fast or slow.

A computer program according to the present invention causes a display device to perform the steps of: displaying a first object representing a magnitude of a predetermined parameter; and displaying a second object in association with the first object, the second object representing an amount of change, per predetermined period, in the magnitude of the parameter represented by the first object. Thus, without presenting awkwardness, it is possible to display predetermined parameters which are in accordance with externally-input information, regardless of whether the response speed is relatively fast or slow.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic representation of a display device 100 according to the present invention.

FIGS. 2A to 2C are illustrations showing transitions of the displayed position and area of a shadow object.

FIG. 3 is a chart explaining a specific exemplary method of displaying a shadow object so as to follow a needle object.

FIG. 4 is a table showing correspondence between revolution data and coordinate data.

FIG. 5 is an illustration of how revolution data and coordinate data may be stored to addresses.

FIG. 6 shows an exemplary rendering of a needle object.

FIG. 7 shows an exemplary rendering of a shadow object.

FIG. 8 shows how rendering data for a needle object and rendering data for a shadow object may be merged.

FIG. 9 is a block diagram showing an exemplary circuit configuration for carrying out the series of steps illustrated in FIG. 3.

FIG. 10 is a schematic illustration of another mode of display by the display device 100 of the present invention.

FIG. 11 is a perspective view schematically showing a game system 1000 including a display device 200 according to the present invention.

FIG. 12 is a schematic representation of the display device 200.

FIG. 13 is a schematic representation of a conventional display device 600 for an instrument panel.

FIG. 14 is a schematic representation of the conventional display device 600 for an instrument panel.

### DETAILED DESCRIPTION OF PREFERRED EMBODIMENTS

Hereinafter, a preferred embodiment of the present invention will be described with reference to the accompanying drawings. The present invention is suitably employed for a display device having a relatively slow response speed, e.g., a liquid crystal display device, and hence the following embodiment will illustrate a liquid crystal display device. However, the present invention is not to be limited to the following embodiment.

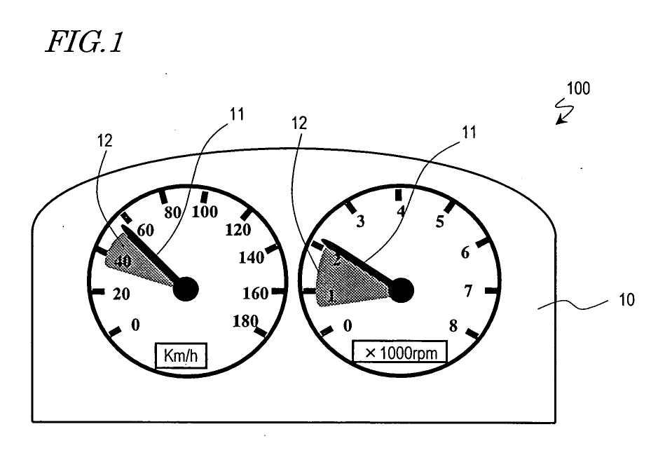

Hereinafter, a liquid crystal display device 100 according to the present embodiment of the invention will be described with reference to FIG. 1.

The liquid crystal display device 100 is a display device for an instrument panel to be mounted in an automotive vehicle. Based on externally-input information, the liquid crystal display device 100 is capable of displaying various parameters concerning the status of an automotive vehicle on a liquid crystal display panel 10. The liquid crystal display panel 10 typically includes a pair of substrates (e.g., glass substrates) and a liquid crystal layer interposed therebetween, and performs display by modulating incident light to the panel with the liquid crystal layer. Although FIG. 1 illustrates an example where vehicle speed and engine revolution are displayed, it will be appreciated that the displayed parameters are not limited thereto. For example, remaining fuel amount, water temperature, remaining battery power, shift lever position, and the like may be displayed.

As shown in FIG. 1, the liquid crystal display device 100 is capable of displaying: bar-like objects resembling needles (hereinafter referred to as “needle objects”) 11; shadow-like objects (hereinafter referred to as “shadow objects”) 12, each of which follows the corresponding. needle object 11; and an object (hereinafter referred to as a “background object”) corresponding to the background including indexes and/or numerals (i.e., the portion other than the needle objects 11 and the shadow objects 12).

Each needle object 11 is displayed so as to rotate around one end in accordance with changes in the magnitude of a parameter (i.e., speed or revolution in the illustrated example), while the position of the other end (which is located near the indexes in the background object) of the needle object 11 indicates the magnitude of the parameter. In other words, each needle object 11 represents the magnitude of an associated parameter through its displayed position.

Each shadow object 12 is displayed so as to follow the corresponding needle object 11 in response to changes in the displayed position of the needle object 11. The shadow object 12 has an area which corresponds to an amount of change in the magnitude, per predetermined period, of the parameter represented by the needle object 11. In other words, each shadow object 12 represents the amount of change (i.e., rate of change per predetermined period) through its area.

Out of the two shadow objects 12 shown in FIG. 1, the shadow object 12 following the needle object 11 which represents the magnitude of vehicle speed represents an amount of change in the magnitude of vehicle speed per predetermined period (for example, an amount of change per unit time, i.e., acceleration). On the other hand, the shadow object 12 following the needle object 11 which represents engine revolution represents an amount of change in the engine revolution per predetermined period.

Each shadow object 12 of the present embodiment is shaped so as to form a sector of a circle whose center (which corresponds to the apex of the sector opposite from its arc) is at one end of the needle object 11. The greater the area of the shadow object 12 is, the greater the amount of change in the magnitude of the associated parameter is.

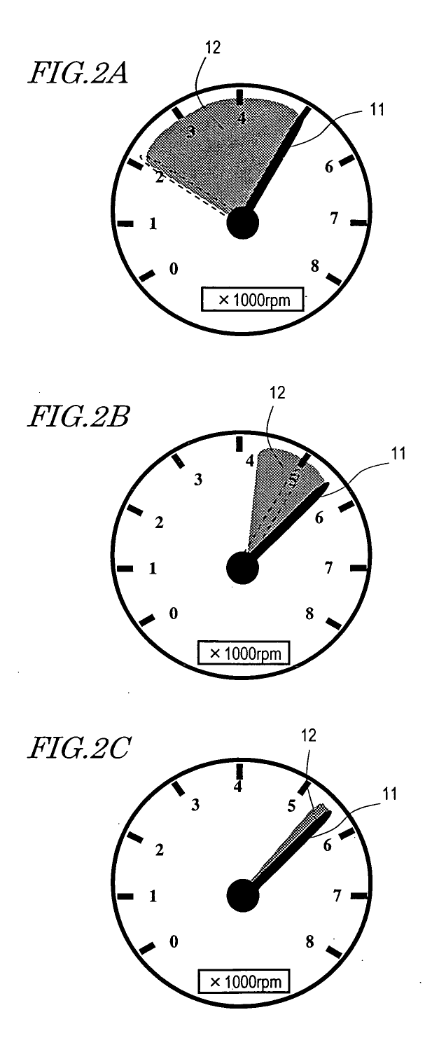

With reference to FIGS. 2A to 2C, the displaying of each shadow object 12 will be specifically described. FIGS. 2A to 2C are illustrations showing transitions of the displayed position and area of one of the shadow objects 12 occurring when the engine revolution is increased.

First, as shown in FIG. 2A, if the revolution is rapidly increased from 2100 rpm to 5000 rpm, the position at which the needle object 11 is displayed rapidly changes (rotates) from a position indicating 2100 rpm (denoted by a broken line in FIG. 2A) to a position indicating 5000 rpm. Meanwhile, the shadow object 12 is displayed so as to follow the needle object 11, while extending over an area which is in accordance with the amount of change in revolution.

Next, as shown in FIG. 2B, if the revolution is gently increased from 5000 rpm to 5500 rpm, the position at which the needle object 11 is displayed gently changes (rotates) from a position indicating 5000 rpm (denoted by a broken line in FIG. 2B) to a position indicating 5500 rpm. Meanwhile, the shadow object 12 is displayed so as to follow the needle object 11, again extending over an area which is in accordance with the amount of change in revolution. However, since the amount of change in revolution is smaller than in the case of FIG. 2A, the shadow object 12 has a smaller area than in the case of FIG. 2A.

Thereafter, if the revolution is maintained at 5500 rpm as shown in FIG. 2C, the position at which the needle object 11 is displayed does not change, but the area of the shadow object 12 gradually decreases, until reaching zero (thus indicating that the amount of change in revolution is zero).

As described above, the display device 100 is capable of displaying each shadow object 12 so as to follow the corresponding needle object 11 (i.e., in the present embodiment, so as to overlap the trajectory of the needle object 11), thus eliminating the awkwardness of afterimages occurring in the case where the display device itself has a relatively slow response speed. Since the area of the shadow object 12 represents an amount of change (per predetermined period) in the magnitude of the parameter represented by the needle object 11, the driver is assisted in realizing the amount of change in the magnitude of the parameter. For example, in the case where the needle objects 11 represent vehicle speed and engine revolution as in the present embodiment, the driver may be able to feel the impact of acceleration better with the shadow objects 12 being displayed. In other words, the display device 100 not only solves the problem of awkwardness associated with a slow response speed, but also provides a more intriguing, novel display to the user.

From the perspective of enhancing the visual recognition of the needle objects 11, it would be preferable that each needle object 11 is displayed with a different color and/or luminance level from the corresponding shadow object 12. From the perspective of suppressing afterimages of the needle objects 11, it would be preferable that each needle object 11 and the corresponding shadow object 12 are displayed in the same hue or similar hues.

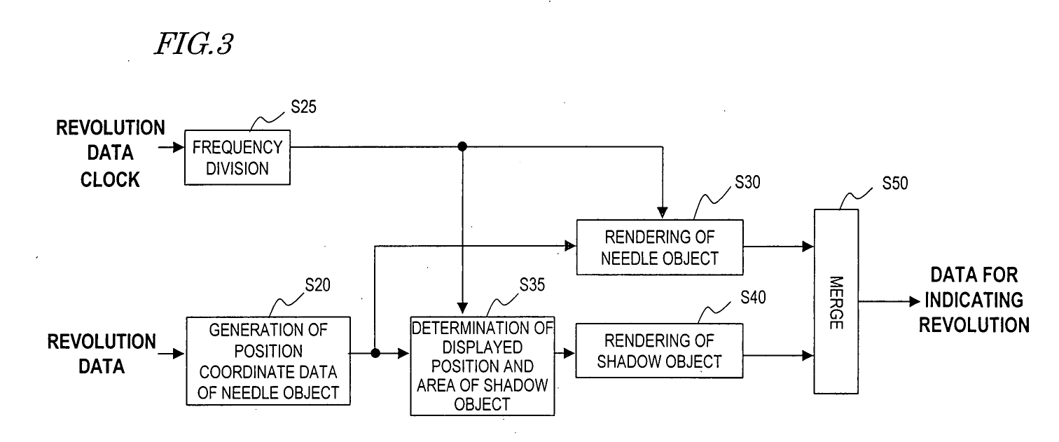

Next, with reference to FIG. 3, a specific exemplary method of displaying each shadow object 12 so as to follow the corresponding needle object 11 will be described. In the following example, it is assumed that revolution data is externally input, with the lapse of every period equal to ⅙ of one frame.

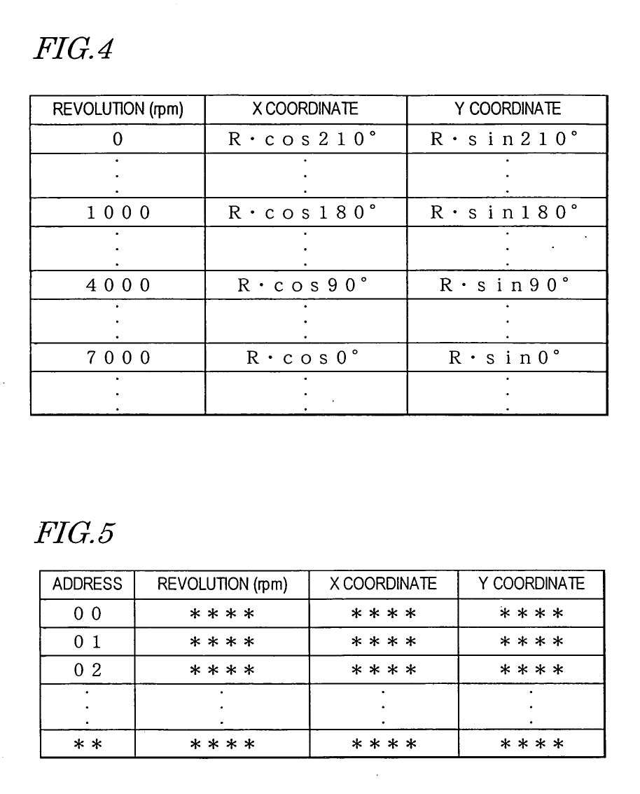

First, based on the externally-input revolution data, coordinate data defining a position at which to display a needle object 11 is periodically (with a period of ⅙ frame) generated (S20). An example of conversion from revolution data to coordinate data is shown in FIG. 4. FIG. 4 shows correspondence between revolution data and an X coordinate and a Y coordinate of one end (i.e., the end proximate to the indexes) of the needle object 11. The correspondence between revolution data and coordinate data in this example is taken on the following basis: the center of the needle-and-dial type meter is defined as the coordinate origin (0,0); and the needle object 11 has a length R.

Each generated coordinate data and each generated revolution data are consecutively stored to predetermined addresses (00, 01, 02, . . . , etc.) as shown in FIG. 5. After data is stored to the last address, data is stored all over from the first address (00) (i.e., overwriting takes place).

Next, based on the stored coordinate data, rendering of the needle object 11 (S30) and rendering of the shadow object 12 (S40) are performed.

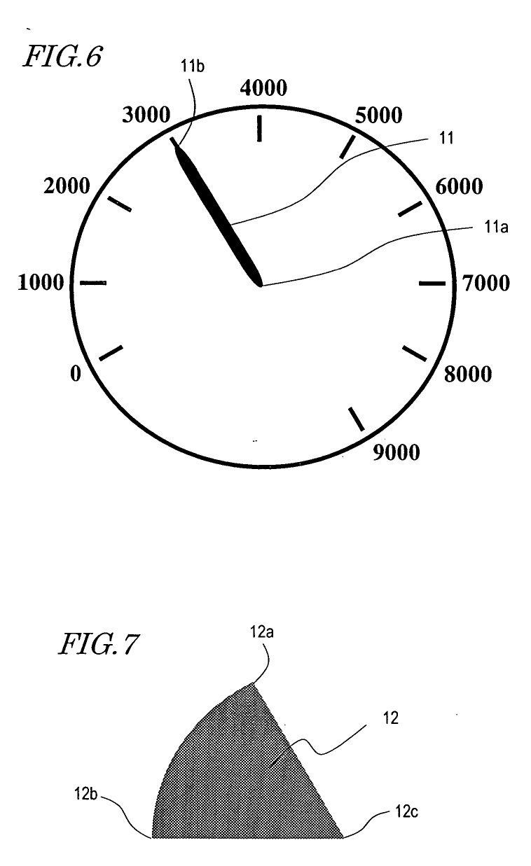

First, rendering of the needle object 11 will be described. Firstly, revolution data (which is externally input with the lapse of every period equal to ⅙ of one frame) is input as a clock signal to a counter (not shown), and output in the form of a timing signal which has been frequency-divided (to ⅙, in this example) (S25). Next, based on the output timing signal, coordinate data in a predetermined address is read from among the stored coordinate data, and used for rendering the needle object 11 (S30). Herein, as shown in FIG. 6, rendering is performed in such a manner that one end 11a of the needle object 11 will be at the coordinate origin, whereas the other end 11b of the needle object 11 will be at a point represented by the coordinate data of the predetermined address which has been read. Note that FIG. 6 exemplifies a needle object 11 indicating a revolution of 3000 rpm, where a portion (indexes) of the background object is also shown for ease of understanding.

Next, rendering of the shadow object 12 will be described. First, through a calculation of the periodically-generated coordinate data as stored over a plurality of periods, a position at which to display the shadow object 12 and an area of the shadow object 12 are determined (S35), and thereafter, rendering of the shadow object 12 is performed based on the displayed position and area which have been determined (S40). Specifically, as shown in FIG. 7, the shadow object 12 is rendered so as to form a sector (of a circle) which connects: a point 12a represented by the coordinate data of the predetermined address which was read during the rendering of the needle object 11; a point 12b represented by the coordinate data of an earlier address; and a coordinate origin 12c. The choice as to from how long ago the coordinate data defining the point 12b should be may arbitrarily be set in accordance with the type of the parameter, the purpose for which the display device is used, and the like. For example, if the coordinate data which was generated n frames ago from the coordinate data defining the point 12a is employed as the coordinate data defining the point 12b (i.e., through a calculation of coordinate data stored over a period corresponding to n frames), the shadow object 12 will be displayed as connecting the current position of the needle object 11 and the position of the needle object 11 from n frames ago.

Thereafter, by merging the rendering data for the needle object 11 and the rendering data for the shadow object 12 as shown in FIG. 8 (S50), data for indicating revolution is obtained. This merging is preferably performed in such a manner that the needle object 11 is displayed with a higher priority over the shadow object 12. In other words, in the case where the needle object 11 and the shadow object 12 should partially overlap with each other, the merging is preferably performed so that the needle object 11 is shown on top of the shadow object 12.

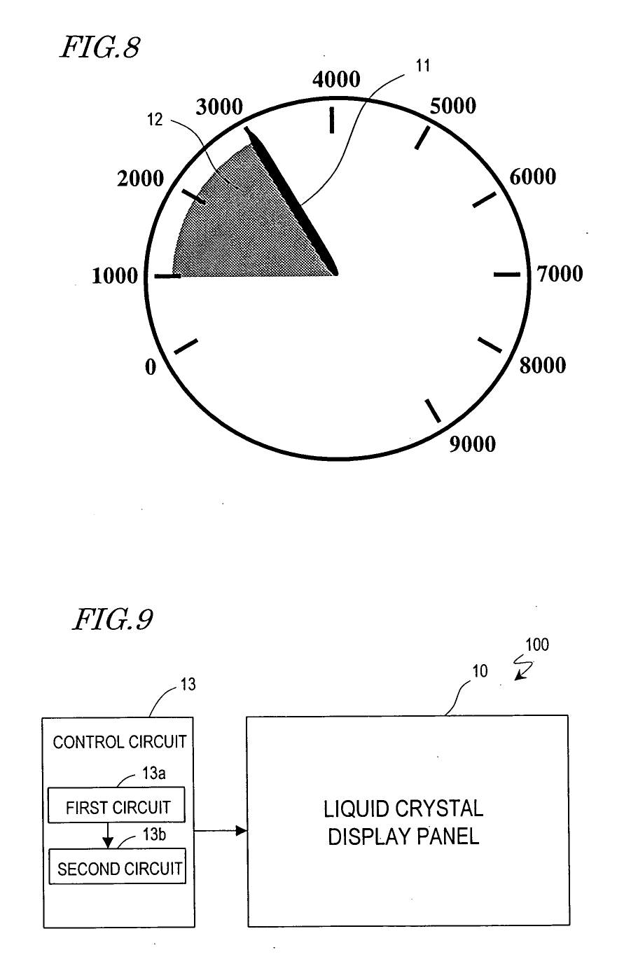

FIG. 9 is a block diagram showing an exemplary circuit configuration for carrying out the series of steps illustrated in FIG. 3. In the example shown in FIG. 9, a control circuit 13 which controls the liquid crystal display panel 10 to display each needle object 11 and each shadow object 12 includes: a first circuit 13a which periodically generates coordinate data defining a position at which to display the needle object 11 based on externally-input information; and a second circuit 13b which determines the position at which to display the shadow object 12 and the area of the shadow object 12 through calculation of the coordinate data which are periodically generated by the first circuit 13a and stored over a plurality of periods. Thus, the control circuit 13 is able to execute the above-described series of steps. The above-described series of steps may be implemented in a software-oriented manner, i.e., by using a computer program which causes the display device 100 to execute the series of steps.

Although the above example illustrates a case where an increase in the vehicle speed or engine revolution occurs, it will be appreciated that these parameters may also have a decrease. Therefore, each shadow object 12 may represent a positive or negative amount of change, per predetermined period, in the magnitude of the parameter represented by the needle object 11. From the perspective of improving the visual recognition of the shadow object 12, the shadow object 12 may selectively indicate only one of a positive amount of change and a negative amount of change. For example, the shadow object 12 may only indicate a rate of increase (and not a rate of decrease) in the vehicle speed or engine revolution per predetermined period. Specifically, in order to only indicate a positive amount of change, rendering of the shadow object 12 may be performed in such a manner that, out of the coordinate data stored over a plurality of periods, no coordinate data is used that corresponds to any parameter values greater than the parameter value (speed or revolution) corresponding to the most recent coordinate data. Conversely, in order to only indicate a negative amount of change, rendering of the shadow object 12 may be performed in such a manner that no coordinate data is used that corresponds to any parameter values smaller than the parameter value corresponding to the most recent coordinate data.

The present embodiment illustrates a case where each needle object 11 represents the magnitude of an associated parameter through its position and the corresponding shadow object 12 represents through its area an amount of change (per predetermined period) in the magnitude of the associated parameter. However, the present invention is not limited thereto. The object (“first object”) representing the magnitude of the parameter may make the representation in any other manner. The object (“second object”) representing an amount of change (per predetermined period) in the magnitude of the parameter only needs to be displayed in association with the first object, and may represent the amount of change in any other manner. Furthermore, the shapes of the respective objects themselves are not limited to those exemplified above.

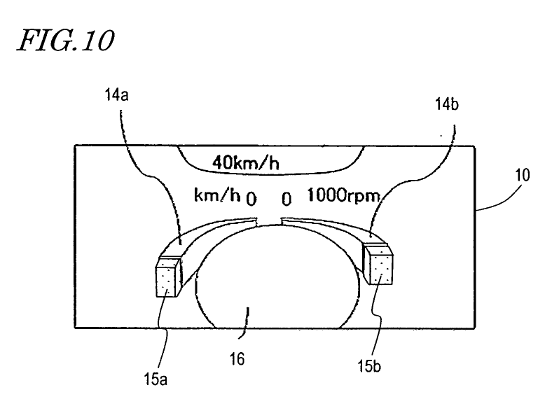

For example, instead of needle objects 11, curved column-like objects 14a and 14b as shown in FIG. 10 may be displayed, each of which represents the magnitude of an associated parameter through its changing size. In the example shown in FIG. 10, the columnar objects 14a and 14b are displayed so as to extend along the periphery of a multi-purpose display region 16. The columnar object 14a which is shown at the left-hand side of FIG. 10 represents speed, whereas the columnar object 14b which is shown at the right-hand side of FIG. 10 represents revolution. Moreover, shadow objects 15a and 15b (which are in the shape of hexahedrons in this example) are displayed in association with the columnar objects 14a and 14b, respectively. Each of the shadow objects 15a and 15b has a size which is in accordance with an amount of change, per predetermined period, in the magnitude of the associated parameter.

As described above, the display device 100 of the present embodiment is capable of, without presenting awkwardness, displaying predetermined parameters which are in accordance with externally-input information, regardless of whether the response speed is relatively fast or slow. Therefore, the display device 100 can be suitably used for an instrument panel of an automotive vehicle. As used herein, an “automotive vehicle” may be any vehicle or machine which is capable of self propulsion and used for passenger or article transportation or moving of objects, e.g., a car, a motorbike, a bus, a truck, a tractor, an airplane, a motorboat, a vehicle for civil engineering use, a train, or the like. It will be appreciated that “automotive vehicles” are not limited to only those which are provided with internal combustion engines such as gasoline engines, but also encompass those provided with electric motors.

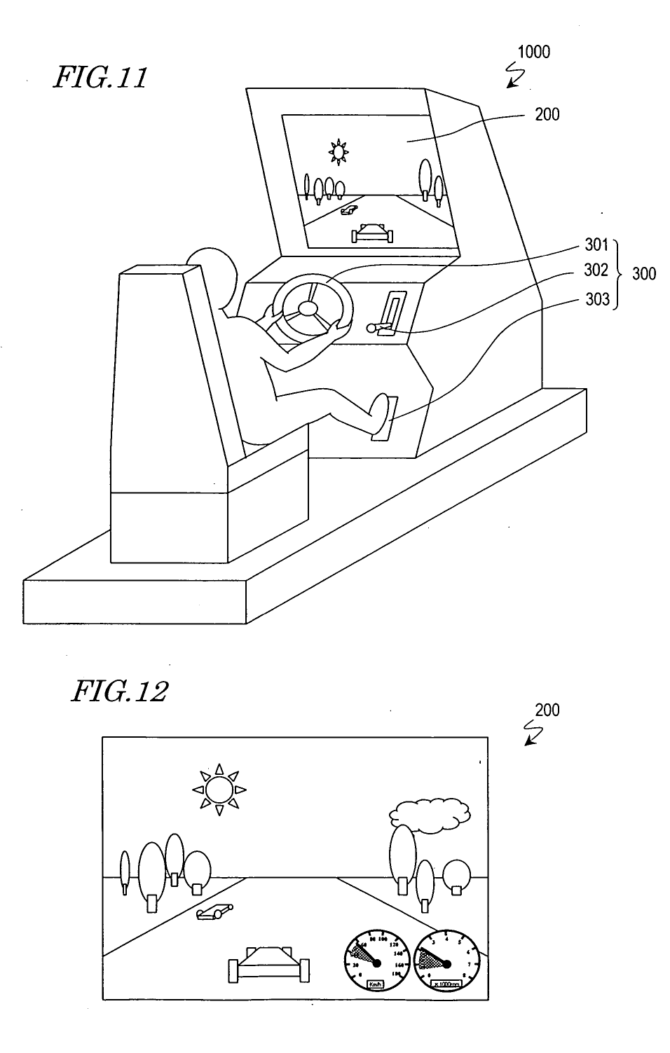

The display device according to the present invention may also be suitably used for a game system. FIG. 11 schematically shows a game system 1000 including a display device according to the present invention.

The game system 1000 comprises a display device 200 and an input device 300 for inputting, to the display device 200, information which is in accordance with user operations. The game system 1000 is used for a user to simulate driving of an automotive vehicle, and thus the input device 300 includes a steering wheel 301, a shift lever 302, and foot pedals 303.

FIG. 12 shows a display screen of the display device 200. While watching such a screen, the user manipulates the steering wheel 301, the shift lever 302, and the foot pedals 303 for simulated driving. As shown in FIG. 12, vehicle speed and engine revolution as determined in accordance with the user operations are displayed on the display screen. Similarly to the display device 100 shown in FIG. 1, the display device 200 is capable of displaying shadow objects 12 so as to follow the respective needle objects 11. Thus, it is possible to display images without presenting awkwardness, regardless of whether the response speed is relatively fast or slow. Moreover, the user is provided with an enhanced acceleration feel.

Now, the length of time for which to display each shadow object 12 will be discussed.

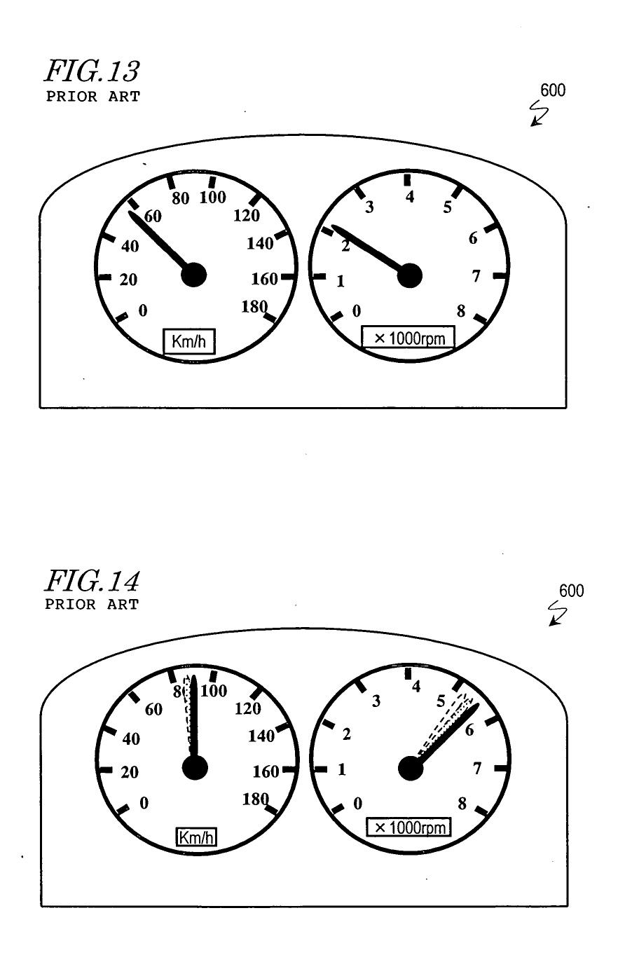

In the case of a general car which travels on public roads, even when stepping on the accelerator pedal while the engine is idling, it would take about one second to bring the revolution from an idling state to about 6000 to 7000 rpm. In the case of employing a liquid crystal display device, if the display device has a refresh rate of 60 Hz (i.e., the amount of time corresponding to one frame is about 16.7 msec), afterimages of the needles may occur as shown in FIG. 14. Therefore, in this case, it may be preferable that each shadow object 12 is displayed for a period of time which is longer than 16.7 msec (which corresponds to one frame), and equal to or less than about 1 sec. For example, if the displaying time of each shadow object 12 is about 200 msec to 400 msec, a sufficient acceleration feel can be obtained, and yet the shadow objects 12 will not appear unnatural.

In a game system, it might be possible to render more exaggerated images of the speedometer and/or the tachometer for an enhanced speeding feel. For example, the indexes of the tachometer may go up to 12000 rpm (rather than just 8000 rpm), and the needle object 11 of the tachometer may be allowed to move from an idling state to a position corresponding to 10000 rpm in about 0.5 seconds. In this case, presumably, the displaying time of the shadow object 12 should also be relatively short for better esthetics. Even when the displaying time is prescribed to be about 70 msec to about 150 msec, the shadow objects 12 will attain sufficient effects.

It will be appreciated that individual preferences may exist for the displaying time for the shadow objects 12. Therefore, a number of preset values of the displaying time may be provided for the user to freely choose from.

Although the present embodiment illustrates a liquid crystal display device as one example, the present invention is not limited thereto. The present invention is also applicable to any other type of display device such as an organic EL display device. However, a particularly outstanding effect of awkwardness prevention based on the suppression of afterimages is provided when a display device with a relatively slow response speed, such as a liquid crystal display device, is used.

According to the present invention, without presenting awkwardness, it is possible to display predetermined parameters which are in accordance with externally-input information, regardless of whether the response speed is relatively fast or slow. The display device according to the present invention is suitably used for an instrument panel to be mounted in an automotive vehicle. The display device according to the present invention is also suitably used for a game system.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This non-provisional application claims priority under 35 USC §119(a) on Patent Applications No. 2004-183479 filed in Japan on Jun. 22, 2004, the entire contents of which are hereby incorporated by reference.

1. A display device comprising a display panel for displaying objects based on externally-input information,
wherein the display device is capable of displaying a first object representing a magnitude of a predetermined parameter on the display panel, and
the display device is capable of displaying a second object in association with the first object, the second object representing an amount of change, per predetermined period, in the magnitude of the parameter represented by the first object.

2. The display device according to claim 1, wherein the first object represents the magnitude of the parameter through a displayed position of the first object.

3. The display device according to claim 2, wherein the second object represents the amount of change through a displayed area of the second object, the second object being displayed so as to follow the first object with changes in the displayed position of the first object.

4. The display device according to claim 1, wherein the first object has a bar-like shape.

5. The display device according to claim 4, wherein the first object having the bar-like shape is displayed so as to rotate around a first end of the first object in accordance with changes in the magnitude of the parameter, while a position of a second end of the first object indicates the magnitude of the parameter.

6. The display device according to claim 5, wherein the second object has a shape forming a sector of a circle whose center is at the first end of the first object.

7. The display device according to claim 1, wherein the displayed area of the second object becomes larger as the amount of change is larger.

8. The display device according to claim 1, wherein the second object selectively represents only a positive or negative amount of change in the magnitude of the parameter per predetermined period.

9. The display device according to claim 1, further comprising a control circuit for controlling the display panel to display the first and second objects.

10. The display device according to claim 9, wherein the control circuit includes: a first circuit for periodically generating coordinate data defining. a position at which to display the first object based on externally-input information; and a second circuit for determining a position at which to display the second object and a displayed area of the second object, through calculation of the coordinate data periodically generated by the first circuit and stored over a plurality of periods.

11. The display device according to claim 1, wherein the display panel is a liquid crystal display panel including a pair of opposing substrates and a liquid crystal layer disposed between the pair of substrates.

12. The display device according to claim 1 as a display device for an instrument panel to be mounted in an automotive vehicle,
wherein the first object represents a magnitude of speed of the automotive vehicle, and the second object represents a magnitude of acceleration of the automotive vehicle.

13. An instrument panel comprising the display device according to claim 12.

14. An automotive vehicle comprising the instrument panel according to claim 13.

15. The display device according to claim 1 as a display device for an instrument panel to be mounted in an automotive vehicle,
wherein the first object represents a number of revolutions of an engine or motor of the automotive vehicle.

16. An instrument panel comprising the display device according to claim 15.

17. An automotive vehicle comprising the instrument panel according to claim 16.

18. A game system comprising: the display device according to claim 1; and an input device for inputting, to the display device, information which is in accordance with an operation by a user.

19. The game system according to claim 18 to be used by the user for simulated driving of an automotive vehicle.

20. The game system according to claim 1.9, wherein the first object represents the magnitude of speed of the automotive vehicle as determined through an operation by the user, and the second object represents the magnitude of acceleration of the automotive vehicle as determined through an operation by the user.

21. The game system according to claim 19, wherein the first object represents a number of revolutions of an engine or motor of the automotive vehicle as determined through an operation by the user.

22. A display device driving method for driving a display device including a display panel for displaying objects based on externally-input information, the method comprising the steps of:
displaying a first object representing a magnitude of a predetermined parameter; and
displaying a second object in association with the first object, the second object representing an amount of change, per predetermined period, in the magnitude of the parameter represented by the first object.

23. The display device driving method according to claim 22, wherein the step of displaying the first object is performed so as to display the first object at a position which is in accordance with the magnitude of the parameter.

24. The display device driving method according to claim 23, wherein the step of displaying the second object is performed so as to display the second object with an area which is in accordance with the amount of change, the second object being displayed so as to follow the first object with changes in the displayed position of the first object.

25. The display device driving method according to claim 24, further comprising the steps of:
periodically generating coordinate data defining a position at which to display the first object based on externally-input information; and
determining a position at which to display the second object and a displayed area of the second object, through calculation of the periodically-generated coordinate data as stored over a plurality of periods.

26. A computer program executable by a display device including a display panel for displaying objects based on externally-input information on the display panel, the computer program causing the display device to perform the steps of:
displaying a first object representing a magnitude of a predetermined parameter; and
displaying a second object in association with the first object, the second object representing an amount of change, per predetermined period, in the magnitude of the parameter represented by the first object.

27. The computer program according to claim 26, wherein the step of displaying the first object is performed so as to display the first object at a position which is in accordance with the magnitude of the parameter.

28. The computer program according to claim 27, wherein the step of displaying the second object is performed so as to display the second object with an area which is in accordance with the amount of change, the second object being displayed so as to follow the first object with changes in the displayed position of the first object.

29. The computer program according to claim 28 further causing the display device to perform the steps of:
periodically generating coordinate data defining a position at which to display the first object based on externally-input information; and
determining a position at which to display the second object and a displayed area of the second object, through calculation of the periodically-generated coordinate data as stored over a plurality of periods.
